(19) United States
(12) Patent Application Publication
(10) Pub. No.: US 2014/0239160 A1
(43) Pub. Date: Aug. 28, 2014

(54) HIGH-SPEED OPTICAL RECEIVER MODULE AND METHOD OF MANUFACTURING THE SAME

(71) Applicant: Electronics and Telecommunications Research Institute, Daejeon (KR)

(72) Inventor: JiHo JOO, Daejeon (KR)

(73) Assignee: Electronics and Telecommunications Research Institute, Daejeon (KR)

(21) Appl. No.: 14/180,917

(22) Filed: Feb. 14, 2014

(30) Foreign Application Priority Data
Feb. 27, 2013 (KR) 10-2013-0021452

(51) Int. Cl. G01J 1/44

(52) U.S. Cl. CPC G01J 1/44
USPC 250/214 A; 250/214 R; 29/825

(57) ABSTRACT

Provided is a photoreceiver module. The module includes: a ceramic substrate formed by stacking a plurality of metallic layers and a plurality of ceramic layers; a high frequency transmission line formed on the ceramic substrate and configured to transmit a high frequency electrical signal; a photodetector mounted on the ceramic substrate and configured to convert the high frequency electronic signal; a power supply line supplying DC power to the photodetector; and a high frequency connector connected to the high frequency transmission line and configured to deliver the high frequency electrical signal to an outside. The photodetector is mounted on a stepped hole manufactured in the ceramic substrate, and a height of each contact point of the photodetector and the high frequency transmission line is corrected by the stepped hole.

### CROSS-REFERENCE TO RELATED APPLICATIONS

This U.S. non-provisional patent application claims priority under 35 U.S.C. §119 of Korean Patent Application No. 10-2013-0021452, filed on Feb. 27, 2013, the entire contents of which are hereby incorporated by reference.

### BACKGROUND OF THE INVENTION

The present invention disclosed herein relates to a photoreceiver module, and more particularly, to a high-speed photoreceiver module capable of simplifying a manufacturing process by using a ceramic substrate manufactured with a stacked layer structure and capable of improving performance by reducing the usage length of a bondwire.

In general, a high-speed photoreceiver module includes an optical system collecting light, a photodetector, an external power supply line, and a high frequency connector. Also, a preamplifier may be used so as to amplify a high frequency signal photoelectrically transformed by a photodetector. Furthermore, the high-speed photoreceiver module may further include a noise reduction circuit for removing noise caused from external power and a function circuit for performing an additional function. Since a signal delivered between a photodetector and a preamplifier and between a preamplifier and a high frequency transmission line is a high-speed signal of more than about 10 Gb/s, the high frequency transmission line and its peripheral part may need to be designed precisely in consideration of parasite components affecting such a high-speed transmission property.

It is recommended that a noise reduction circuit reducing low frequency noise of DC power be attached to a power input unit of a photodetector and a preamplifier. The reason is that a high-performance high-speed preamplifier used in a high-speed photoreceiver module is sensitive electromagnetically. The noise reduction circuit includes a combination of a resistor, a capacitor, and an inductor. As such a noise reduction circuit is disposed and is connected to a power input unit, an additional printed circuit board is manufactured. Therefore, an internal structure of a photoreceiver module becomes complex and additional costs arise.

A connection between an individual part and a printed circuit board uses a bondwire. Typically, as the length of a bondwire becomes shorter, high-speed transmission characteristic becomes better. In order to reduce the usage length of a bondwire, an additional supporting part is configured to adjust a height difference between a photodetector, a preamplifier, a noise reduction circuit, a high frequency transmission line, and a high frequency connector. However, when a height difference between a plurality of components is adjusted by using an additional supporting part, manufacturing processes become complex and there are limitations in reducing the usage length of a bondwire. Therefore, if a stepped hole is formed by using a ceramic substrate manufactured with a stacked layer structure and a plurality of components are mounted on the ceramic substrate, manufacturing processes become simple and the usage length of a bondwire is reduced effectively.

### SUMMARY OF THE INVENTION

The present invention provides a high-speed photoreceiver module capable of simplifying a manufacturing process by using a ceramic substrate manufactured with a stacked layer structure and capable of improving performance and a method of manufacturing the same.

Embodiments of the present invention provide photoreceiver modules including: a ceramic substrate formed by stacking a plurality of metallic layers and a plurality of ceramic layers; a high frequency transmission line formed on the ceramic substrate and configured to transmit a high frequency electrical signal; a photodetector mounted on the ceramic substrate and configured to convert the high frequency electronic signal; a power supply line supplying DC power to the photodetector; and a high frequency connector connected to the high frequency transmission line and configured to deliver the high frequency electrical signal to an outside, wherein the photodetector is mounted on a stepped hole manufactured in the ceramic substrate, and a height of each contact point of the photodetector and the high frequency transmission line is corrected by the stepped hole.

In some embodiments, the height of the each contact point of the photodetector and the high frequency transmission line may be the same in a vertical direction from a bottom of the ceramic substrate.

In other embodiments, the plurality of metallic layers may include a first metallic layer connected to a ground and a second metallic layer connected to the first metallic layer through a metallic via.

In still other embodiments, the plurality of metallic layers may be formed of at least one material of W, Mb, Cu, and Ag.

In even other embodiments, the plurality of ceramic layers may include a first ceramic layer serving as a supporting part and a second ceramic layer where the high frequency transmission line is formed.

In yet other embodiments, the plurality of ceramic layers may be formed of at least one of alumina, aluminum nitride, and silicon carbide.

In further embodiments, the power supply line may be connected to a circuit pattern formed on the ceramic substrate and the circuit pattern may be connected to the photodetector.

In still further embodiments, the modules may further include a noise reduction circuit reducing a low frequency noise of the DC power, and components of the noise reduction circuit may be mounted on the circuit pattern.

In even further embodiments, a ground portion of the circuit pattern may be connected to the plurality of metallic layers through a metallic via.

In yet further embodiments, the high frequency transmission line may be formed of at least one of a single-end transmission line or a differential transmission line, or transmission line arrays.

In yet further embodiments, the high frequency transmission line may be formed of at least one of a microstrip line, a coplanar waveguide, a grounded coplanar waveguide.

In other embodiments of the present invention, photoreceiver modules include: a ceramic substrate formed by stacking a plurality of metallic layers and a plurality of ceramic layers; a high frequency transmission line formed on the ceramic substrate and configured to transmit a high frequency electronic signal; a photodetector mounted on the ceramic substrate an configured to convert an optical signal into the high frequency electronic signal; a preamplifier amplifying the high frequency electronic signal received from the photodetector; a power supply line supplying DC power to the photodetector and the preamplifier; and a high frequency connector connected to the high frequency transmission line and configured to deliver the high frequency electrical signal to an outside, wherein the photodetector is mounted on a first stepped hole manufactured in the ceramic substrate; the preamplifier is mounted on a second stepped hole manufactured in the ceramic substrate; a height of each contact point of the photodetector and the preamplifier is corrected by the first stepped hole; and a height of each contact point of the preamplifier and the high frequency transmission line is corrected by the second stepped hole.

In some embodiments, the height of the each contact point of the photodetector and the preamplifier may be the same in a vertical direction from a bottom of the ceramic substrate; and the height of the each contact point of the preamplifier and the high frequency transmission line may be the same in a vertical direction from a bottom of the ceramic substrate.

In still other embodiments of the present invention, provided is a method of manufacturing a photoreceiver module. The method includes: forming a ceramic substrate including a stepped hole by stacking a plurality of metallic layers and a plurality of ceramic layers; forming a high frequency transmission line transmitting a high frequency electrical signal, on the ceramic substrate; mounting a photodetector converting an optical signal into the high frequency electrical signal, on the stepped hole; and connecting a high frequency connector delivering the high frequency electrical signal to an outside, to the high frequency transmission line, wherein a height of each contact point of the photodetector and the high frequency transmission line is corrected by the stepped hole.

In some embodiments, the height of the each contact point of the photodetector and the high frequency transmission line may be the same in a vertical direction from a bottom of the ceramic substrate.

In other embodiments, the forming of the ceramic substrate includes: forming a first ceramic layer including a first metallic via and the stepped hole; forming a first metallic layer at a bottom of the first ceramic layer to be connected to a ground; filling the first metallic via with a material that is the same as that of the first metallic layer; forming the second metallic layer on the first ceramic layer; forming a second ceramic layer including second metallic via and the stepped hole, on the second metallic layer; and filling the second metallic via with a material that is the same as that of the second metallic layer.

In still other embodiments, the method may further include forming a circuit pattern on the ceramic substrate, and connecting a power supply line supplying DC power to the photodetector to the circuit pattern, wherein the circuit pattern is connected to the photodetector.

In still other embodiments, the method may further include mounting a noise reduction circuit removing a low frequency noise of a DC power on the circuit pattern.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a perspective view illustrating a photoreceiver module according to an embodiment of the present invention;

FIG. 2 is a perspective view illustrating the ceramic substrate of FIG. 1;

FIG. 3 is a sectional view taken along the line X-X′ of the ceramic substrate of FIG. 2;

FIG. 4 is a perspective view illustrating the first ceramic layer of the ceramic substrate shown in FIG. 2;

FIG. 5 is a perspective view illustrating first and second metallic layers of the ceramic substrate shown in FIG. 2;

FIG. 6 is a perspective view illustrating the second ceramic layer of the ceramic layer shown in FIG. 2;

FIG. 7 is a perspective view illustrating the uppermost layer of the ceramic substrate shown in FIG. 2;

FIG. 8 is a flowchart illustrating a method of manufacturing a photoreceiver module according to an embodiment of the present invention;

FIG. 9 is a perspective view illustrating a photoreceiver module according to another embodiment of the present invention;

FIG. 10 is a perspective view illustrating the ceramic substrate of FIG. 9;

FIG. 11 is a sectional view taken along the line Y-Y′ of the ceramic substrate of FIG. 10;

FIG. 12 is a perspective view illustrating a photoreceiver module according to another embodiment of the present invention;

FIG. 13 is a perspective view illustrating the ceramic substrate of FIG. 12;

FIG. 14 is a perspective view illustrating a photoreceiver module according to another embodiment of the present invention;

FIG. 15 is a perspective view illustrating the ceramic substrate of FIG. 14.

### DETAILED DESCRIPTION OF PREFERRED EMBODIMENTS

It should be understood that the above general description and the following detailed description are all exemplary, and additional description of the claimed invention is provided. Reference numerals are shown in preferred embodiments of the present invention, and their examples are displayed in reference drawings. In any case, like reference numerals refer to like elements throughout.

Hereinafter, a photoreceiver module is used as an example of an electronic device to describe the features and functions of the present invention. However, those skilled in the art easily understand other advantages and performances based on the content listed herein. Moreover, the present invention may be implemented or applied through other embodiments. Furthermore, the detailed description may be modified or changed without departing from the scopes, technical ideas, and other purposes of the present invention.

Hereinafter, it will be described about an exemplary embodiment of the present invention in conjunction with the accompanying drawings.

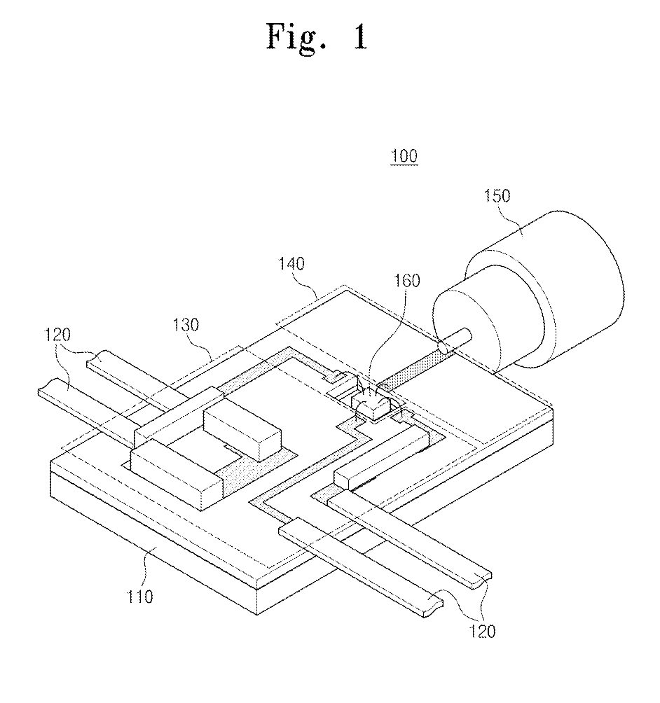

FIG. 1 is a perspective view illustrating a photoreceiver module according to an embodiment of the present invention. Referring to FIG. 1, the photoreceiver module 100 converts an optical signal received through an optical system (not shown) into a high frequency electrical signal and transmits the converted high frequency electrical signal to an external system through a high frequency connector 150.

A ceramic substrate 110 has a stacked layer structure of a metallic layer and a ceramic layer. Metallic layers are connected through a metallic via. A sub mount 140 is formed together when the ceramic substrate 110 is stacked. A circuit unit 130 and a photodetector 160 are mounted on the ceramic substrate 110. A stepped hole is manufactured in the ceramic substrate 110. The stepped hole is manufactured in consideration of the height of the photodetector 160. Due to the stepped hole, the positions of contact points of the circuit unit 130, the photodetector 160, and the sub mount 140 are close to each other. That is, due to the stepped hole, each height of the contact points becomes the same in a vertical direction from the bottom of the ceramic substrate 110.

A power supply line 120 is connected to the circuit unit 130. The power supply line 120 supplies necessary power to the photoreceiver module 100. The power supply line 120 supplies DC power to the circuit unit 130 and the photodetector 160.

The circuit unit 130 is configured by mounting circuit components on a circuit pattern stacked on the ceramic substrate 110. The circuit components include a resistor, an inductor, a capacitor, and an IC chip. The circuit unit 130 may include components of various functions. For example, the circuit unit 130 includes a noise reduction circuit. The noise reduction circuit reduces low frequency noise of DC power inputted through the power supply line 120. The reason is that the DC power inputted through the power supply line 120 still has many noise components. The circuit unit 130 may include additional circuits performing functions necessary for the photoreceiver module 100 such as a circuit controlling the photodetector 160.

The sub mount 140 delivers a high frequency signal converted by the photodetector 160 to the high frequency connector 150. The sub mount 140 is designed and manufactured to fit high-speed high frequency signal delivery. Therefore, when the specification of the photoreceiver module 100 is determined, the size and property of the sub mount 140 are determined. When the size of the sub mount 140 is determined, the ceramic substrate 110 is manufactured to fit the size. The sub mount 140 is manufactured together while the ceramic substrate 110 is stacked.

The high frequency connector 150 receives a high frequency signal through the sub mount 140. The high frequency connector 150 transmits the received high frequency signal to the outside. The specification of the high frequency connector 150 is predetermined in general.

The photodetector 160 converts an optical signal received through an optical system (not shown) into a high frequency electrical signal. The photodetector 160 is mounted on a stepped hole of the ceramic substrate 110. The stepped hole is manufactured in consideration of the height of the photodetector 160.

The circuit unit 130 is connected to the photodetector 160 through a bondwire. The photodetector 160 is connected to the sub mount 140 through a bond wire. As the usage length of a bondwire becomes longer, the high frequency property of the photoreceiver module 100 becomes worse. Due to the stepped hole, the positions of contact points of the circuit unit 130, the photodetector 160, and the sub mount 140 are close to each other. That is, due to the stepped hole, the height of each contact point is the same in a vertical direction from the bottom of the ceramic substrate 110. Therefore, the usage length of a bondwire becomes shorter. As a result, the high frequency property of the photoreceiver module 100 is improved.

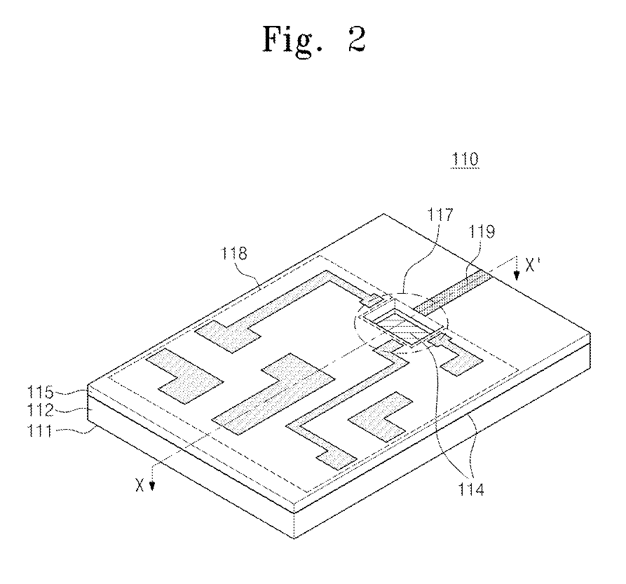

FIG. 2 is a perspective view illustrating the ceramic substrate of FIG. 1. Referring to FIG. 2, the ceramic substrate 110 is formed by stacking a metallic layer and a ceramic layer. The ceramic layer is formed by using a ceramic material used for manufacturing a stacked layer structure. The ceramic material may include alumina, aluminum nitride, and silicon carbide. The ceramic substrate 110 may include a low temperature co-fired ceramic substrate (LTCC) or a high temperature co-fired ceramic substrate (HTCC). It is apparent to those skilled in the art that there is no limit to a ceramic material and substrate type if they are used for manufacturing a stacked layer structure.

A first metallic layer 111 is a thin metallic layer. A material of the first metallic layer 111 is determined in consideration of thermal and electrical properties. For example, the material of the first metallic layer 111 may include W, Mb, Cu, or Ag. W or Mb is used for the HTCC. Cu or Ag is used for the LTCC. The first metallic layer 111 is connected to the ground.

A first ceramic layer 112 is a dielectric layer formed of ceramic material. The first ceramic layer 112 separates the first metallic layer 111 from a second metallic layer 114. The first ceramic layer 112 serves as a physical supporting part to fix individual components mounted on the ceramic substrate 110.

The second metallic layer 114 is a thin metallic layer. A material of the second metallic layer 114 is the same as the first metallic layer 111. The reason is to maintain the thermal and electrical properties of the ceramic substrate 110. Therefore, if the thermal and electrical properties are maintained constantly, the second metallic layer 114 may be stacked with a different material than the first metallic layer 111. The second metallic layer 114 is connected to the first metallic layer 111 through a metallic via penetrating the first ceramic layer 112. The metallic via is formed of the same material as the first and second metallic layers 111 and 114.

A second ceramic layer 115 is a dielectric layer formed of ceramic material. The second ceramic layer 115 is formed of the same material as the first ceramic layer 112. The reason is to uniformly maintain the thermal and electrical properties of the ceramic substrate 110. The thickness of the second ceramic layer 115 is determined according to the specification of the sub mount 140 of FIG. 1. For example, in order to maintain the impedance of a high frequency transmission line 119 to be about 50Ω, the second ceramic layer 115 is manufactured with a thickness of about 150 μm.

A stepped hole 117 is manufactured in a portion of the ceramic substrate 110 where the photodetector 160 is mounted. The stepped hole 117 is manufactured in consideration of the height of the photodetector 160. Due to the stepped hole 117, the positions of contact points of the circuit pattern 118, the photodetector 160, and the high frequency transmission line 119 are close to each other. That is, due to the stepped hole 117, the heights of the contact points are the same in a vertical direction from the bottom of the ceramic substrate 110. Therefore, the usage length of a bondwire becomes shorter.

The circuit pattern 118 is drawn according to a configuration of the circuit unit 130. The circuit pattern 118 is formed on the second ceramic layer 115. A portion connected to the ground of the circuit pattern 118 is connected to the second metallic layer 114 through a metallic via. The metallic via is formed of the same material as the second metallic layer 114. The circuit pattern 118 is formed of the same material as the second metallic layer 114.

The high frequency transmission line 119 is manufactured to be fit for transmitting a high frequency signal according to the specification of the sub mount 140. For example, the high frequency transmission line 119 is manufactured to deliver a high frequency signal at a speed of more than about 10 Gb/s. The high frequency transmission line 119 is manufactured to maintain its impedance to be about 50Ω. The high frequency transmission line 119 may be manufactured as one of a microstrip line, a coplanar waveguide, a grounded coplanar waveguide, or a combination thereof. The high frequency line 119 is formed at the position of the sub mount 140. The high frequency transmission line 119 is formed on the second ceramic layer 115.

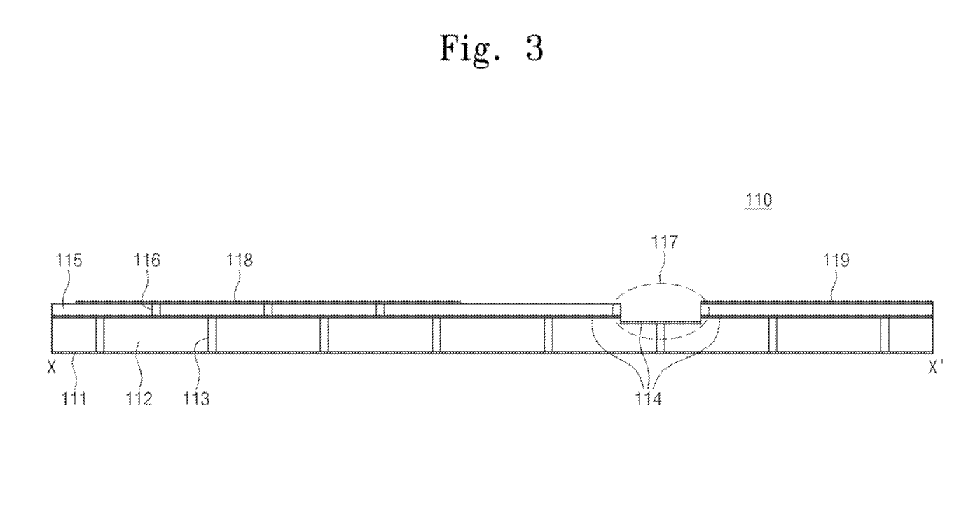

FIG. 3 is a sectional view taken along the line X-X′ of the ceramic substrate of FIG. 2. Referring to FIG. 3, the first ceramic layer 112 is formed between the first metallic layer 111 and the second metallic layer 114. The first metallic layer 111 and the second metallic layer 114 are connected to each other through the metallic via 113. The metallic via 113 penetrates the first ceramic layer 112 and are filled with the same material as the first and second metallic layers 111 and 114. The second ceramic layer 115 is formed on the second metallic layer 114. The circuit pattern 118 is formed at the position where the circuit unit 130 of FIG. 1 is mounted. The metallic via 116 is formed at a portion connected to the ground of the circuit pattern 118, as penetrating the second ceramic layer 115. The metallic via 116 is filled with the same material as the second metallic layer 114. The stepped hole 117 is manufactured at a position where the photodetector 160 is mounted. The stepped hole 117 is manufactured in consideration of the height of the photodetector 160. The high frequency transmission line 119 is formed at the position of the sub mount 140. The high frequency transmission line 119 is formed on the second ceramic layer 115.

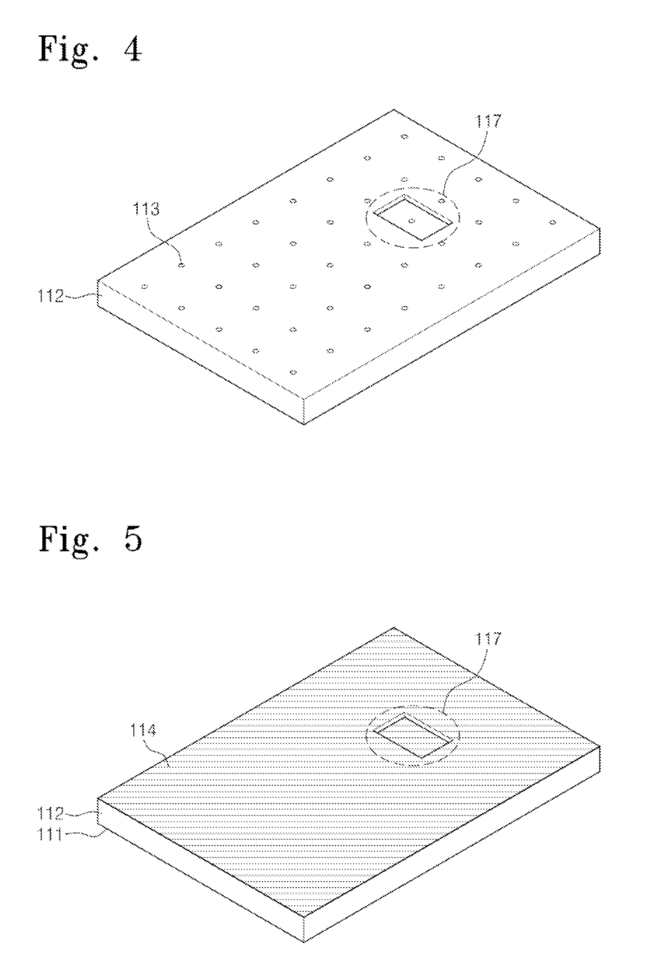

FIGS. 4 to 8 are views illustrating manufacturing processes of the ceramic substrate 110. FIG. 4 is a perspective view illustrating the first ceramic layer of the ceramic substrate shown in FIG. 2. Referring to FIG. 4, the first ceramic layer 112 is formed first. The first ceramic layer 112 is a dielectric layer formed of ceramic material. The first ceramic layer 112 is formed by stacking several ceramic layers where a hole of the metallic via 113 and a hole of the stepped hole 117 are formed. The first ceramic layer 112 is formed by heating the stacked several ceramic layers.

FIG. 5 is a perspective view illustrating first and second metallic layers of the ceramic substrate shown in FIG. 2. Referring to FIG. 5, the first metallic layer 111 is formed below the first ceramic layer 112. The second metallic layer 114 is formed on the first ceramic layer 112. The metallic via 113 penetrates the first ceramic layer 112 and is filled with the same material as the first and second metallic layers 111 and 114.

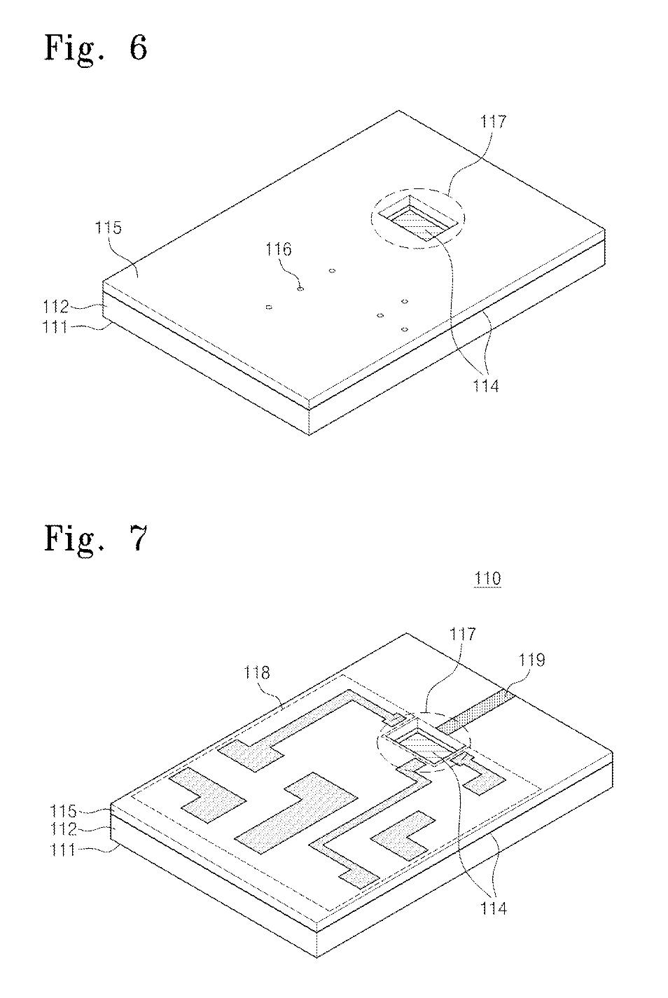

FIG. 6 is a perspective view illustrating the second ceramic layer of the ceramic layer shown in FIG. 2. Referring to FIG. 6, the second ceramic layer 115 may be formed on the second metallic layer 114 and may be formed of the same material as the first ceramic layer 112. The second ceramic layer 115 is formed by stacking several ceramic layers where a hole of the metallic via 116 and a hole of the stepped hole 117 are formed. The second ceramic layer 115 is formed by heating the stacked several ceramic layers. The metallic via 116 is formed by penetrating the second ceramic layer 115 at a portion connected to the ground of the circuit pattern 118. The metallic via 116 is filled with the same material as the second metallic layer 114. The stepped hole 117 is formed at a position where the photodetector 160 of FIG. 1 is mounted. The stepped hole 117 is formed in consideration of the height of the photodetector 160.

FIG. 7 is a perspective view illustrating the uppermost layer of the ceramic substrate shown in FIG. 2. The circuit pattern 118 is formed at a position where the circuit unit 130 of FIG. 1 is mounted. The circuit pattern 118 is formed on the second ceramic layer 115. The circuit pattern 118 is formed of the same material as the first and second metallic layers 111 and 114. The high frequency transmission line 119 is formed at the position of the sub mount 140. The high frequency transmission line 119 is formed on the second ceramic layer 115. Through these processes, the ceramic substrate 110 is completed.

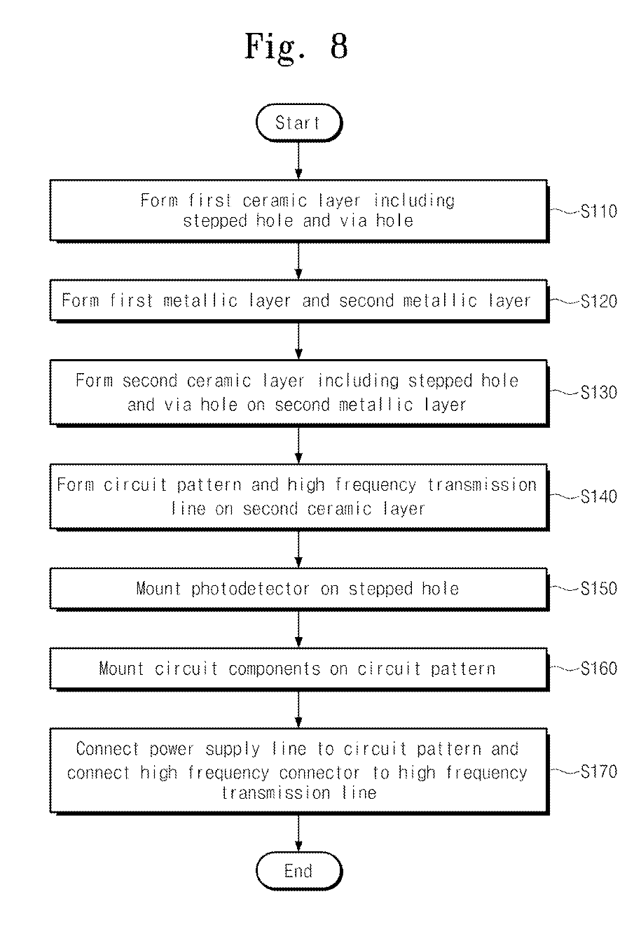

FIG. 8 is a flowchart illustrating a method of manufacturing a photoreceiver module according to an embodiment of the present invention. Hereinafter, this will be described with reference to FIGS. 1 to 7.

In operation S110, the first ceramic layer 112 is formed first. The first ceramic layer 112 is a dielectric layer formed of ceramic material. The first ceramic layer 112 is formed by stacking several ceramic layers where a hole of the metallic via 113 and a hole of the stepped hole 117 are formed. The first ceramic layer 112 is formed by heating the stacked several ceramic layers.

In operation S120, the first metallic layer 111 and the second metallic layer 114 are formed. The first metallic layer 111 is formed below the first ceramic layer 112. The second metallic layer 114 is formed on the first ceramic layer 112. The metallic via 113 is filled with the same material as the first and second metallic layers 111 and 114 are formed.

In operation S130, the second ceramic layer 115 is formed on the second metallic layer 114 and is formed of the same material as the first ceramic layer 112. The second ceramic layer 115 is formed by stacking several ceramic layers where a hole of the metallic via 116 and a hole of the stepped hole 117 are formed. The second ceramic layer 115 is formed by heating the stacked several ceramic layers. The metallic via 116 is formed by penetrating the second ceramic layer 115 at a portion connected to the ground of the circuit pattern 118. The metallic via 116 is filled with the same material as the second metallic layer 114. The stepped hole 117 is formed at a position where the photodetector 160 is mounted. The stepped hole 117 is formed in consideration of the height of the photodetector 160.

In operation S140, the circuit pattern 118 is formed at a position where the circuit unit 130 is mounted. The circuit pattern 118 is formed on the second ceramic layer 115. The circuit pattern 118 is formed of the same material as the first and second metallic layers 111 and 114. The high frequency transmission line 119 is formed at the position of the sub mount 140. The high frequency transmission line 119 is formed on the second ceramic layer 115.

In operation S150, the photodetector 160 is mounted at a portion of the stepped hole 117. The photodetector 160 is connected to the circuit pattern 118 and the high frequency transmission line 119 through a bondwire.

In operation S160, circuit components are mounted on the circuit pattern 118.

In operation S170, the power supply line 120 is connected to the high frequency connector 150. The power supply line 120 is connected to the circuit pattern 118. The high frequency connector 150 is connected to the high frequency transmission line 119.

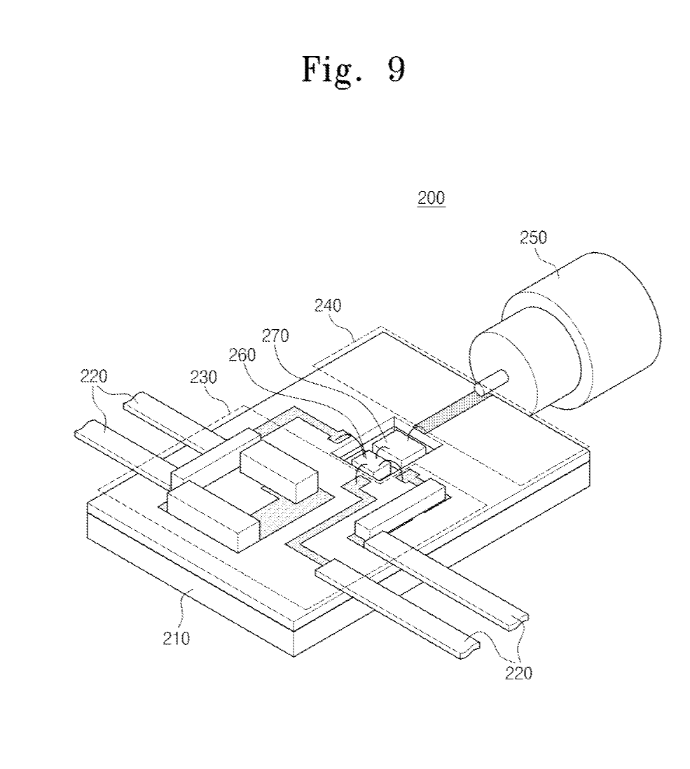

FIG. 9 is a perspective view illustrating a photoreceiver module according to another embodiment of the present invention. Referring to FIG. 9, a photoreceiver module 200 includes a photodetector 260 and a preamplifier 270. Therefore, a ceramic substrate 210 includes a stepped hole having two stages.

The ceramic substrate 210 includes a stacked layer structure of a metallic layer and a ceramic layer. Metallic layers are connected to each other through a metallic via. The ceramic substrate 210 serves as a supporting part of individual components. A power supply line 220 is connected to a circuit unit 230. The power supply line 220 supplies necessary power to the photoreceiver module 200. The circuit unit 230 is configured by mounting circuit components on a circuit pattern stacked on the ceramic substrate 210. The circuit unit 230 may include circuits of various functions. A sub mount 240 delivers a high frequency signal amplified by the preamplifier 270 to a high frequency connector 250. The sub mount 240 is formed together while the ceramic substrate 210 is stacked. The high frequency connector 250 receives a high frequency signal through the sub mount 240. The high frequency connector 250 transmits the received high frequency signal to the outside.

The photodetector 260 converts an optical signal received through an optical system (not shown) into a high frequency electrical signal. The photodetector 260 is mounted on the first stage of a stepped hole in the ceramic substrate 210. Therefore, the first stage of the stepped hole is manufactured in consideration of the height of the photodetector 260.

The preamplifier 270 amplifies a high frequency signal received from the photodetector 260. The amplifier high frequency signal is delivered to the sub mount 240. The preamplifier 270 is mounted on the second stage of the stepped hole in the ceramic substrate 210. Therefore, the second stage of the stepped hole is manufactured in consideration of the height of the preamplifier 270.

The circuit unit 230 and the photodetector 260, or the circuit unit 230 and the preamplifier 270 are connected to each other through a bondwire. The photodetector 260 and the preamplifier 270 are connected to each other through a bondwire. The preamplifier 270 and the sub mount 240 are connected to each other through a bondwire. As the usage length of a bondwire becomes longer, the high frequency property of the photoreceiver module 200 becomes worse. Due to the stepped hole, the positions of contact points of the circuit unit 230, the photodetector 260, the preamplifier 270, and the sub mount 240 are close to each other. That is, due to the stepped hole, the height of each contact point is the same in a vertical direction from the bottom of the ceramic substrate 210. Therefore, the usage length of a bondwire becomes shorter. As a result, the high frequency property of the photoreceiver module 200 is improved.

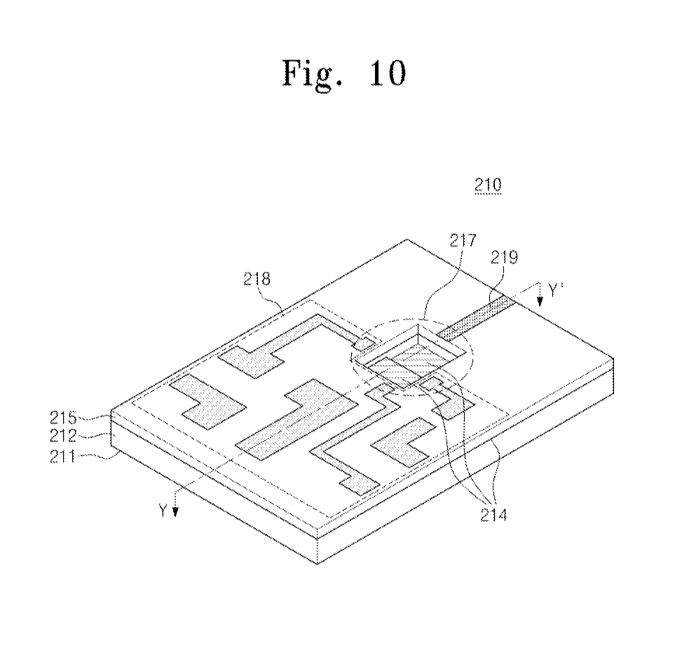

FIG. 10 is a perspective view illustrating the ceramic substrate of FIG. 9. Referring to FIG. 10, the ceramic substrate 210 is formed by stacking a metallic layer and a ceramic layer. The ceramic layer is formed by using a ceramic material used for manufacturing a stacked layer structure. A first metallic layer 211 is a thin metallic layer. The first metallic layer 211 is connected to the ground. A first ceramic layer 212 is a dielectric layer formed of ceramic material. The first ceramic layer 212 separates the first metallic layer 211 from a second metallic layer 214. The first ceramic layer 212 serves as a physical supporting part to fix components mounted on the ceramic substrate 210. The second metallic layer 214 is a thin metallic layer. The second metallic layer 214 is connected to the first metallic layer 211 through a metallic via penetrating the first ceramic layer 212. A second ceramic layer 215 is a dielectric layer formed of ceramic material. The thickness of the second ceramic layer 215 is determined according to the specification of the sub mount 240 of FIG. 10.

A stepped hole 217 is manufactured in a portion of the ceramic substrate 210 where the photodetector 260 and the preamplifier 270 are mounted. The stepped hole 217 has two stages. The first state of the stepped hole 217 is manufactured in consideration of the height of the photodetector 260. The second stage of the stepped hole 217 is manufactured in consideration of the height of the preamplifier 270. Due to the stepped hole 217, the positions of contact points of a circuit pattern 218, the photodetector 260, the preamplifier 270, and a high frequency transmission line 219 are close to each other. That is, due to the stepped hole 217, the heights of the contact points are the same in a vertical direction from the bottom of the ceramic substrate 210. Therefore, the high frequency property of the photoreceiver module 200 is improved.

The circuit pattern 218 is drawn according to a configuration of the circuit unit 230. The circuit pattern 218 is formed on the second ceramic layer 215. A portion connected to the ground of the circuit pattern 218 is connected to the second metallic layer 214 through a metallic via. The circuit pattern 218 is formed of the same material as the first and second metallic layers 211 and 214.

The high frequency transmission line 219 is manufactured to be fit for transmitting a high frequency signal according to the specification of the sub mount 240. The high frequency transmission line 219 is formed on the position of the sub mount 240. The high frequency transmission line 219 is formed on the second ceramic layer 215.

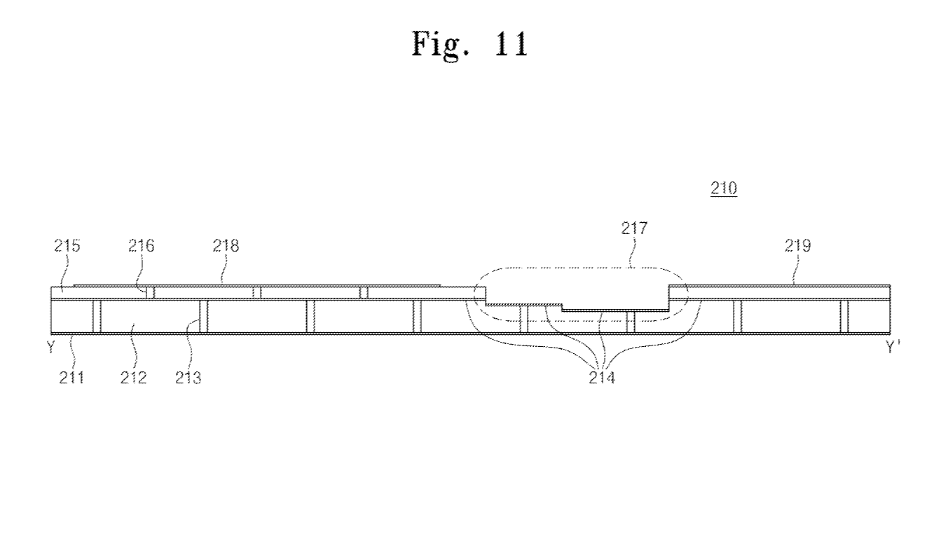

FIG. 11 is a sectional view taken along the line Y-Y′ of the ceramic substrate of FIG. 10. Referring to FIG. 11, the first ceramic layer 212 is formed between the first metallic layer 211 and the second metallic layer 214. The first metallic layer 211 and the second metallic layer 214 are connected to each other through the metallic via 213. The metallic via 213 penetrates the first ceramic layer 212 and are filled with the same material as the first and second metallic layers 211 and 214. The second ceramic layer 215 is formed on the second metallic layer 214. The circuit pattern 218 is formed at the position where the circuit unit 230 of FIG. 9 is mounted. The metallic via 216 is formed at a portion connected to the ground of the circuit pattern 218, as penetrating the second ceramic layer 215. The metallic via 216 is filled with the same material as the second metallic layer 214. The stepped hole 217 is manufactured at a position where the photodetector 260 and the preamplifier 270 are mounted. The stepped hole 217 has two stages. The first stage of the stepped hole 217 is manufactured in consideration of the height of the photodetector 260. The second stage of the stepped hole 217 is manufactured in consideration of the height of the preamplifier 270. The high frequency transmission line 219 is formed on the second ceramic layer 215 according to the position of the sub mount 240.

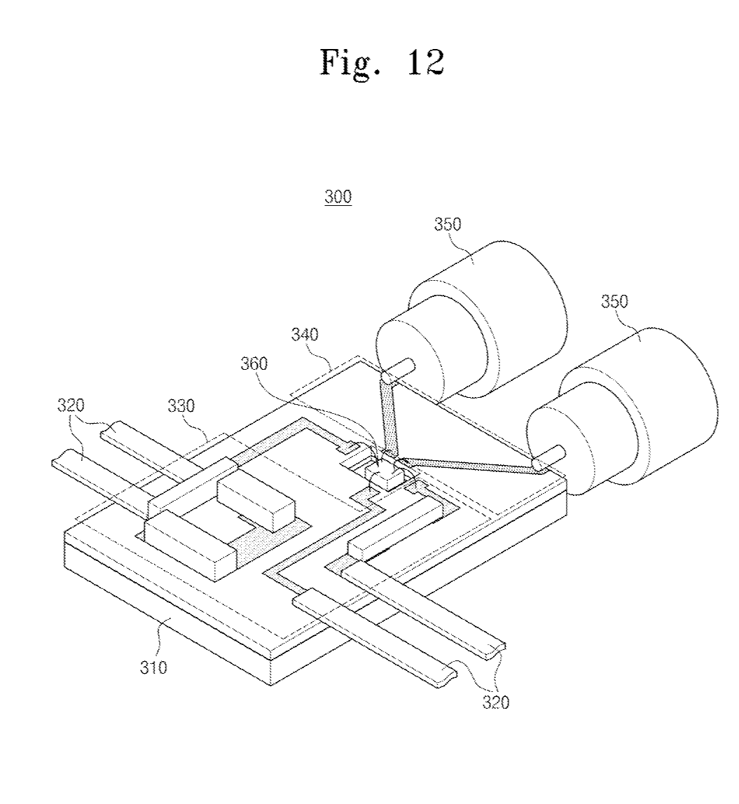

FIG. 12 is a perspective view illustrating a photoreceiver module according to another embodiment of the present invention. Referring to FIG. 12, the photoreceiver module 300 includes a photodetector 360 and a sub mount 340 of a differential transmission line.

A ceramic substrate 310 has a stacked layer structure of a metallic layer and a ceramic layer. Metallic layers are connected to each other through a metallic via. The ceramic substrate 310 serves as a supporting part of individual components. A power supply line 320 is connected to a circuit unit 330. The power supply line 320 supplies necessary power to the photoreceiver module 300. The circuit unit 330 is configured by mounting circuit components on a circuit pattern stacked on the ceramic substrate 310. The circuit unit 330 may include circuits of various functions.

The sub mount 340 delivers a high frequency signal converted by the photodetector 360 to a high frequency connector 350. The sub mount 340 has a differential transmission line. The sub mount 340 of the differential transmission line includes two high frequency transmission lines. The sub mount 340 is manufactured together while the ceramic substrate 310 is stacked. The high frequency connector 350 receives a high frequency signal through the sub mount 340. The high frequency connector 350 transmits the received high frequency signal to the outside.

The photodetector 360 converts an optical signal received through an optical system (not shown) into a high frequency electrical signal. The photodetector 360 is mounted on a stepped hole portion of the ceramic substrate 310. The stepped hole is manufactured in consideration of the height of the photodetector 360.

The circuit unit 330 and the photodetector 360 are connected to each other through a bondwire. The photodetector 360 and the sub mount 340 are connected to each other through a bondwire. As the usage length of a bondwire becomes longer, the high frequency property of the photoreceiver module 300 becomes worse. Due to the stepped hole, the positions of contact points of the circuit unit 330, the photodetector 360, and the sub mount 340 are close to each other. That is, due to the stepped hole, the height of each contact point is the same in a vertical direction from the bottom of the ceramic substrate 310. Therefore, the usage length of a bondwire becomes shorter. As a result, the high frequency property of the photoreceiver module 300 is improved.

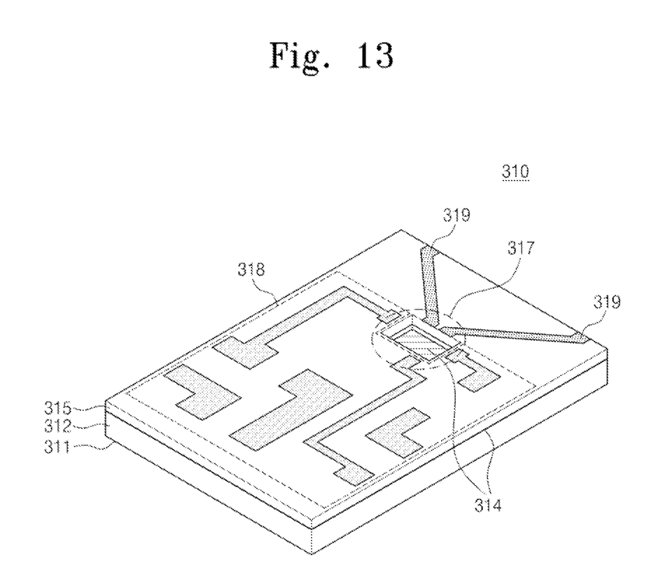

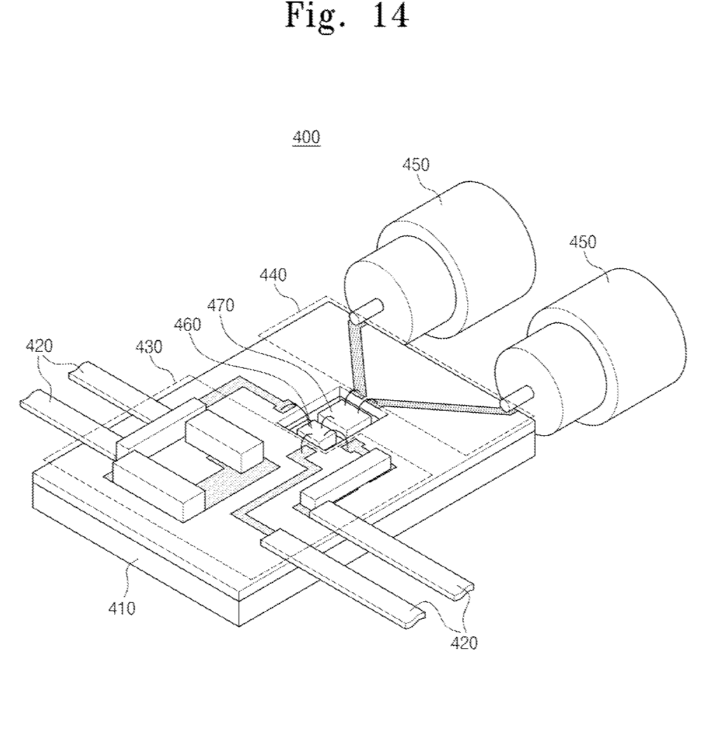

FIG. 13 is a perspective view illustrating the ceramic substrate of FIG. 12. Referring to FIG. 13, the ceramic substrate 310 is formed by stacking a metallic layer and a ceramic layer. The ceramic layer is formed by using a ceramic material used for manufacturing a stacked layer structure. The first metallic layer 311 is a thin metallic layer. The first metallic layer 311 is connected to the ground. A first ceramic layer 312 is a dielectric layer formed of ceramic material. The first ceramic layer 312 separates the first metallic layer 311 from a second metallic layer 314. The first ceramic layer 312 serves as a physical supporting part to fix components mounted on the ceramic substrate 310. The second metallic layer 314 is a thin metallic layer. The second metallic layer 314 is connected to the first metallic layer 311 through a metallic via penetrating the first ceramic layer 312. The metallic via is formed of the same material as the first and second metallic layers 311 and 314. A second ceramic layer 315 is a dielectric layer formed of ceramic material. The thickness of the second ceramic layer 315 is determined according to the specification of the sub mount 340 of FIG. 13. A stepped hole 317 is manufactured at a portion of the ceramic substrate 310 where the photodetector 360 is mounted. The stepped hole 317 is manufactured in consideration of the height of the photodetector 360. A circuit pattern 318 is drawn according to a configuration of the circuit unit 330. The circuit pattern 318 is stacked on the second ceramic layer 315. A portion connected to the ground in the circuit pattern 318 is connected to the second metallic layer 314 through a metallic via. The metallic via is formed of the same material as the second metallic layer 314.

The high frequency transmission line 319 is manufactured to be fit for transmitting a high frequency signal according to the specification of the sub mount 340. The sub mount 340 of a differential transmission line includes two high frequency transmission lines 319. The high frequency transmission line 319 is formed on the position of the sub mount 340. The high frequency transmission line 319 is formed on the second ceramic layer 315.

FIG. 14 is a perspective view illustrating a photoreceiver module according to another embodiment of the present invention. Referring to FIG. 14, the photoreceiver module 400 includes a photodetector 460, a preamplifier 470, and a sub mount 440 of a differential transmission line.

A ceramic substrate 410 has a stacked layer structure of a metallic layer and a ceramic layer. Metallic layers are connected to each other through a metallic via. The ceramic substrate 410 serves as a supporting part of individual components. A power supply line 420 is connected to a circuit unit 430. The power supply line 420 supplies necessary power to the photoreceiver module 400. The circuit unit 430 is configured by mounting circuit components on a circuit pattern stacked on the ceramic substrate 410. The circuit unit 430 may include circuits of various functions.

The sub mount 440 delivers a high frequency signal converted by the photodetector 460 to a high frequency connector 450. The sub mount 440 has a differential transmission line. The sub mount 440 of the differential transmission line includes two high frequency transmission lines. The sub mount 440 is manufactured together while the ceramic substrate 410 is stacked. The high frequency connector 450 receives a high frequency signal through the sub mount 440. The high frequency connector 450 transmits the received high frequency signal to the outside.

The photodetector 460 converts an optical signal received through an optical system (not shown) into a high frequency electrical signal. The photodetector 460 is mounted on the first state of a stepped hole in the ceramic substrate 410. Therefore, the first state of the stepped hole is manufactured in consideration of the height of the photodetector 460. The preamplifier 470 amplifies a high frequency signal received from the photodetector 440. The preamplifier 470 is mounted on the second state of a stepped hole in the ceramic substrate 410. Therefore, the second state of the stepped hole is manufactured in consideration of the height of the preamplifier 470.

The circuit unit 430 and the photodetector 460 or the preamplifier 470 are connected to each other through a bondwire. The photodetector 460 and the preamplifier 470 are connected to each other through a bondwire. The preamplifier 470 and the sub mount 440 are connected through a bond wire. As the usage length of a bondwire becomes longer, the high frequency property of the photoreceiver module 400 becomes worse. Due to the stepped hole, the positions of contact points of the circuit unit 430, the photodetector 460, the preamplifier 470, and the sub mount 440 are close to each other. That is, due to the stepped hole, the height of each contact point is the same in a vertical direction from the bottom of the ceramic substrate 410. Therefore, the usage length of a bondwire becomes shorter. As a result, the high frequency property of the photoreceiver module 400 is improved.

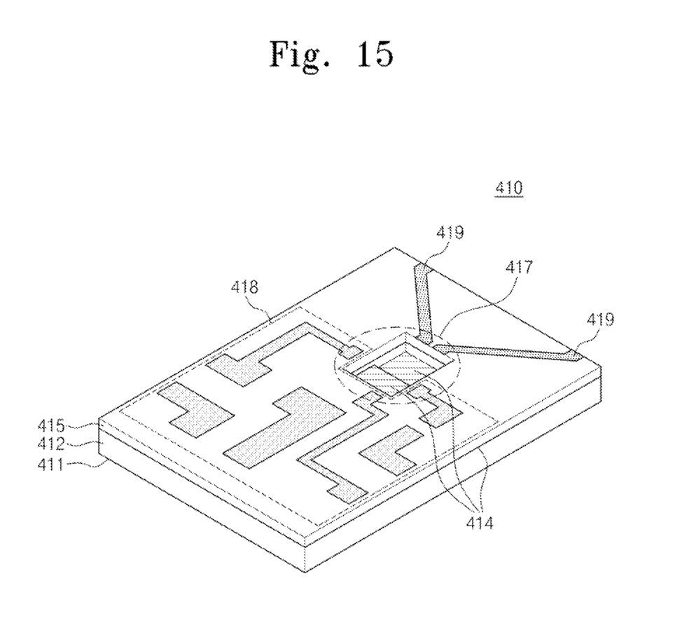

FIG. 15 is a perspective view illustrating the ceramic substrate of FIG. 14. Referring to FIG. 15, the ceramic substrate 410 is formed by stacking a metallic layer and a ceramic layer. The ceramic layer is formed by using a ceramic material used for manufacturing a stacked layer structure. A first metallic layer 411 is a thin metallic layer. The first metallic layer 411 is connected to the ground. A first ceramic layer 412 is a dielectric layer formed of ceramic material. The first ceramic layer 412 separates the first metallic layer 411 from a second metallic layer 414. The first ceramic layer 412 serves as a physical supporting part to fix components mounted on the ceramic substrate 410. The second metallic layer 414 is a thin metallic layer. The second metallic layer 414 is connected to the first metallic layer 411 through a metallic via penetrating the first ceramic layer 412. The metallic via is formed of the same material as the first and second metallic layers 411 and 414. A second ceramic layer 415 is a dielectric layer formed of ceramic material. The thickness of the second ceramic layer 415 is determined according to the specification of the sub mount 440 of FIG. 15.

A stepped hole 417 is manufactured at a portion of the ceramic substrate 410 where the photodetector 460 and the preamplifier 470 are mounted. The stepped hole 417 has two stages. The first stage of the stepped hole 417 is manufactured in consideration of the height of the photodetector 460. The second stage of the stepped hole 417 is manufactured in consideration of the height of the preamplifier 470. A circuit pattern 418 is drawn according to a configuration of the circuit unit 430. The circuit pattern 418 is stacked on the second ceramic layer 415. A portion connected to the ground in the circuit pattern 418 is connected to the second metallic layer 414 through a metallic via. The metallic via is formed of the same material as the second metallic layer 414. A high frequency transmission line 419 is manufactured to be fit for transmitting a high frequency signal according to the specification of the sub mount 440. The sub mount 440 of a differential transmission line includes two high frequency transmission lines 419. The high frequency transmission line 419 is stacked on the position of the sub mount 440. The high frequency transmission line 419 is formed on the second ceramic layer 415.

As described above, a single-end transmission line or a differential transmission line is used as an example of the high frequency transmission line. However, it is apparent to those skilled in the art that the high frequency transmission line is configured with a plurality of lines or transmission line arrays.

According to the above embodiments of the present invention, provided are a high-speed photoreceiver module capable of simplifying a manufacturing process by using a ceramic substrate manufactured with a stacked layer structure and capable of improving performance and a method of manufacturing the same.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A photoreceiver module comprising:
a ceramic substrate formed by stacking a plurality of metallic layers and a plurality of ceramic layers;
a high frequency transmission line formed on the ceramic substrate and configured to transmit a high frequency electrical signal;
a photodetector mounted on the ceramic substrate and configured to convert the high frequency electronic signal;
a power supply line supplying DC power to the photodetector; and
a high frequency connector connected to the high frequency transmission line and configured to deliver the high frequency electrical signal to an outside,
wherein the photodetector is mounted on a stepped hole manufactured in the ceramic substrate, and a height of each contact point of the photodetector and the high frequency transmission line is corrected by the stepped hole.

2. The module of claim 1, wherein the height of the each contact point of the photodetector and the high frequency transmission line is the same in a vertical direction from a bottom of the ceramic substrate.

3. The module of claim 1, wherein the plurality of metallic layers comprise a first metallic layer connected to a ground and a second metallic layer connected to the first metallic layer through a metallic via.

4. The module of claim 1, wherein the plurality of metallic layers are formed of at least one material of W, Mb, Cu, and Ag.

5. The module of claim 1, wherein the plurality of ceramic layers comprise a first ceramic layer serving as a supporting part and a second ceramic layer where the high frequency transmission line is formed.

6. The module of claim 1, wherein the plurality of ceramic layers are formed of at least one of alumina, aluminum nitride, and silicon carbide.

7. The module of claim 1, wherein the power supply line is connected to a circuit pattern formed on the ceramic substrate and the circuit pattern is connected to the photodetector.

8. The module of claim 7, further comprising a noise reduction circuit reducing a low frequency noise of the DC power, and components of the noise reduction circuit are mounted on the circuit pattern.

9. The module of claim 7, wherein a ground portion of the circuit pattern is connected to the plurality of metallic layers through a metallic via.

10. The module of claim 1, wherein the high frequency transmission line is formed of at least one of a single-end transmission line or a differential transmission line, or a transmission line arrays.

11. The module of claim 1, wherein the high frequency transmission line is formed of at least one of a microstrip line, a coplanar waveguide, a grounded coplanar waveguide.

12. A photoreceiver module comprising:
a ceramic substrate formed by stacking a plurality of metallic layers and a plurality of ceramic layers;
a high frequency transmission line formed on the ceramic substrate and configured to transmit a high frequency electronic signal;
a photodetector mounted on the ceramic substrate a configured to convert an optical signal into the high frequency electronic signal;
a preamplifier amplifying the high frequency electronic signal received from the photodetector;
a power supply line supplying DC power to the photodetector and the preamplifier; and
a high frequency connector connected to the high frequency transmission line and configured to deliver the high frequency electrical signal to an outside,
wherein
the photodetector is mounted on a first stepped hole manufactured in the ceramic substrate;
the preamplifier is mounted on a second stepped hole manufactured in the ceramic substrate;
a height of each contact point of the photodetector and the preamplifier is corrected by the first stepped hole; and
a height of each contact point of the preamplifier and the high frequency transmission line is corrected by the second stepped hole.

13. The module of claim 12, wherein the height of the each contact point of the photodetector and the preamplifier is the same in a vertical direction from a bottom of the ceramic substrate; and
the height of the each contact point of the preamplifier and the high frequency transmission line is the same in a vertical direction from a bottom of the ceramic substrate.

14. A method of manufacturing a photoreceiver module, the method comprising:
forming a ceramic substrate including a stepped hole by stacking a plurality of metallic layers and a plurality of ceramic layers;
forming a high frequency transmission line transmitting a high frequency electrical signal, on the ceramic substrate;
mounting a photodetector converting an optical signal into the high frequency electrical signal, on the stepped hole; and
connecting a high frequency connector delivering the high frequency electrical signal to an outside, to the high frequency transmission line,
wherein a height of each contact point of the photodetector and the high frequency transmission line is corrected by the stepped hole.

15. The module of claim 14, wherein the height of the each contact point of the photodetector and the high frequency transmission line is the same in a vertical direction from a bottom of the ceramic substrate.

16. The module of claim 14, wherein the forming of the ceramic substrate comprises:
forming a first ceramic layer including a first metallic via and the stepped hole;
forming a first metallic layer at a bottom of the first ceramic layer to be connected to a ground;
filling the first metallic via with a material that is the same as that of the first metallic layer;
forming the second metallic layer on the first ceramic layer;
forming a second ceramic layer including second metallic via and the stepped hole, on the second metallic layer; and
filling the second metallic via with a material that is the same as that of the second metallic layer.

17. The method of claim 14, further comprising:
forming a circuit pattern on the ceramic substrate; and
connecting a power supply line supplying DC power to the photodetector to the circuit pattern,
wherein the circuit pattern is connected to the photodetector.

18. The method of claim 17, further comprising mounting a noise reduction circuit removing a low frequency noise of a DC power on the circuit pattern.
